(19) United States
(12) Patent Application Publication
(10) Pub. No.: US 2021/0041882 A1
(43) Pub. Date: Feb. 11, 2021

(54) Path Follower with Limited Steering Rate Controller

(71) Applicant: Robotic Research, LLC, Gaithersburg, MD (US)

(72) Inventors: Alberto Daniel Lacaze, Potomac, MD (US); Karl Nicholas Murphy, Rockville, MD (US)

(73) Assignee: Alberto Daniel Lacaze, Gaithersburg, MD (US)

(21) Appl. No.: 16/536,509

(22) Filed: Aug. 9, 2019

(51) Int. Cl. G05D 1/02; B60W 30/09; B60W 40/109; B62D 5/04; B60W 30/18

(52) U.S. Cl. CPC G05D 1/0223; B60W 30/09; B60W 30/18145; B62D 5/04; B60W 40/109

(57) ABSTRACT

As autonomous vehicles are starting to become a reality, accurate path following is needed. Pure Pursuit and Vector Pursuit algorithms are commonly used to control the steering actuators. Unfortunately, these algorithms do not take under consideration that real world actuators have steering rates that have maximum acceleration and speed of the changes to the steering and therefore the curvature rates of the vehicle as it is following a trajectory. This is even more evident in large vehicles that require significant torque to move the steering column like trucks and heavy industrial equipment. Therefore, if these vehicles attempt to closely follow trajectories at higher speed, the vehicles will undoubtedly understeer as the steering actuators do not have enough time/power to catch up with the curvatures dictated by the path even if kinematically and dynamically, the vehicles can safely perform the turns. The invention presented relates to the creation of a control system that takes under consideration these maximum curvature rates as part of the control of the autonomous vehicle. The invention involves the development of a control system that controls to follow an arbitrary trajectory comprising a vehicle with an actuated steering column, where the actuator has a maximum steering rate and/or maximum steering acceleration and/or a maximum steering jerk; a system for controlling the vehicle speed (actuated accelerator and/or brake), a trajectory (possibly composed of waypoints) that dictates the path to be followed by the vehicle, a maximum allowed deviation from that trajectory, and a controller that modifies the velocity of the autonomous vehicle to allow the vehicle to follow the trajectory within the maximum allowed deviation.

### CROSS-REFERENCES TO OTHER APPLICATIONS

None.

### BACKGROUND

### 1. Field of the Invention

This invention relates to the creation of a control system that takes under consideration the maximum curvature rates as part of the control of the autonomous vehicle. It involves having a control system that controls to follow an arbitrary trajectory comprising a vehicle with an actuated steering column, where the actuator has a maximum steering rate and/or maximum steering acceleration and/or a maximum steering jerk; a system for controlling the vehicle speed (actuated accelerator and/or brake); a trajectory (possibly composed of waypoints) that dictates the path to be followed by the vehicle, a maximum allowed deviation from that trajectory and a controller that modifies the velocity of the autonomous vehicle to allow the vehicle to follow the trajectory within the maximum allowed deviation.

### 2. Description of Related Art

The statements in this section merely provide background information related to the present disclosure and may not constitute prior art.

Vehicles such as cars, off-road vehicles, agricultural tractors, or self-propelled agricultural implements may be used in a variety of tasks such as to transport people or goods from one location to another, to tow agricultural implements to harvest, plow, cultivate, spray, etc.). Traditionally, vehicles are manually operated by a human. That is, the steering and speed of the \vehicle are controlled by an operator driving the vehicle. Unfortunately, the operator may not drive the vehicle along an efficient path from one location to another location as compared to autonomously controlled vehicles.

Accordingly, the number of applications for automated ground vehicles has been rapidly increasing. Examples include autonomous mining trucks, tractors, military target vehicles, and durability testing of passenger vehicles. It is convenient to construct desired paths out of tangentially connected circular arc and straight-line segments, which have been shown to be optimal in terms of path length. Unfortunately, such paths cannot actually be driven if the steering angle is produced by a servo system, which introduces a finite steering rate causing lag, and most autonomous vehicles typically include rate-limited servo steering systems that have a maximum turning rate.

Previous applications in this area derived schemes for driving such as paths under the assumption that transitions between segments were “unplanned”. In these applications, the control system simply switches to a new path segment at some time ahead of actually reaching the transition point. The rudimentary process is one way of dealing with assumptions of linear lag and a nonlinear rate-=limited actuator. However, these previous applications may experience path segment transition as “disturbances” that the control system must continuously overcome, which may lead to control system degradation over time. Furthermore, previous applications may not achieve optimal transitions between path segments.

Autonomous path planning is required for autonomous and semi-autonomous highway driving and for advanced driver assistance systems such as collision avoidance. Path planning must be reactive to changes in a host vehicle dynamics and other static and dynamic objections on the road. The planned path must result in safe collision-free path within the road boundaries which must also be feasible for the host vehicle control in light of the vehicle dynamic constraints such as maximum lateral acceleration/jerk. Known path planning techniques do not consider either the dynamics of the host vehicle and other moving-target vehicles or are to computationally intensive for real-time applications to be reactive in appropriate time.

There has not been any reports in the patent literature on the creation of a control system that takes into consideration the maximum curvature rates as part of the control of the autonomous vehicles.

There has been a system and method developed for controlling autonomous vehicles in which they are configured to create and execute optimal drivable path plans for autonomous vehicles based on clothoid segments. This invention is disclosed in U.S. Pat. No. 9,746,854.

A method of adaptively re-generating a planned path for an autonomous driving maneuver has been developed. An object map is generated based on the sensed objects in a road of travel. A timer is reset and actuated. A planned path is generated for autonomously maneuvering the vehicle around the sensed objects. The vehicle is autonomously maneuvered along the planned path. The object map is updated based on sensed data from the vehicle-based devices. A safety check is performed for determining whether the planned path is feasible based on the updated object map. The planned path is re-generated in response to a determination that the existing path is infeasible, otherwise a determination is made as to whether the timer has expired. If the timer has not expired, then a safety check is re-performed; otherwise, a return is made to re-plan the path. This invention is disclosed in U.S. Pat. No. 9,868,443.

There has been an invention that relates to an apparatus and method for controlling a vehicle. A path controller for guiding an autonomous vehicle along a desired path may include an input module that may receive input signals such as, a normal error signal that indicates an off-path deviation of the autonomous vehicle relative to a desired path, a heading signal, and a curvature signal associated with the autonomous vehicle. The path controller may also include a curvature rate module that calculates a curvature rate output signal to guide the autonomous vehicle along the desired path and a communication module that communicates the curvature rate output signal to a steering control system. This invention is disclosed in U.S. Pat. No. 10,139,826.

The vehicular curvature state is identified, and the vehicle path curvature limits are determined. A curvature performance profile to follow is determined based in part by the vehicle path curvature limits. A direction of the vehicle is controlled based in part by the curvature performance profile. This invention is disclosed in U.S. Pat. No. 10,202,144.

Again, it is worth noting that there has not been a control system that takes into consideration the maximum curvature rates as part of the control of the autonomous vehicles.

### SUMMARY OF THE INVENTION

The invention presented relates to the creation of a control system that takes under consideration these maximum curvature rates as part of the control of the autonomous vehicle.

The invention involves the development of a control system that controls to follow an arbitrary trajectory comprising a vehicle with an actuated steering column, where the actuator has a maximum steering rate and/or maximum steering acceleration and/or a maximum steering jerk; a system for controlling the vehicle speed (actuated accelerator and/or brake), a trajectory (possibly composed of waypoints) that dictates the path to be followed by the vehicle, a maximum allowed deviation from that trajectory, and a controller that modifies the velocity of the autonomous vehicle to allow the vehicle to follow the trajectory within the maximum allowed deviation.

### BRIEF DESCRIPTION OF THE DRAWINGS

The present invention is described in the detailed description that follows, with reference to the following noted drawings that illustrate non-limiting examples of embodiments of the present invention, and in which like reference numerals represent similar parts throughout the drawings.

FIG. 1 shows the desired path and allowable deviation for the path following controller and monitors the position, speed, acceleration, and jerk. The simulators control the steering, brake, and throttle actuators with limited response.

FIG. 2A shows a path with multiple segments such as a straight segment, two clothoid segment, and two constant curvature segments. FIG. 2B shows the curvature of a vehicle's path being proportional to the steering wheel position.

FIG. 3A shows the case scenario where if the steering actuator is not fast enough, the vehicle cannot follow the clothoid and the resulting path deviates from the desired path.

FIG. 3B shows that the distance along path is equal to time multiplied by speed. If the vehicle drives slower, it has more time to make the turn. It would be able to follow exactly or not do as poorly.

FIG. 4 shows a schematic of the system the steering, brake, throttle actuator command set that goes to a simulator which influences the steering, brake, throttle actuator performance capability and the autonomous vehicle follows a resulting path which is the desired path.

### DETAILED DESCRIPTION OF THE INVENTION

Elements in the Figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

Unless specifically set forth herein, the terms “a,” “an,” and “the” are not limited to one element, but instead should be read as meaning “at least one.” The terminology includes the words noted above, derivatives thereof, and words of similar import.

The particulars shown herein are given as examples and are for the purposes of illustrative discussion of the embodiments of the present invention only and are presented in the cause of providing what is believed to be the most useful and readily understood description of the principles and conceptual aspects of the present invention.

In this invention, a control system is developed that controls to follow an arbitrary trajectory comprising a vehicle with an actuated steering column, where the actuator has a maximum steering rate and/or maximum steering acceleration and/or a maximum steering jerk, a system for controlling the vehicle speed (actuated accelerator and/or brake), a trajectory (possibly composed of waypoints) that dictates the path to be followed by the vehicle, a maximum allowed deviation from the trajectory, and a controller that modifies the velocity of the autonomous vehicle to allow the vehicle to follow the trajectory within the maximum allowed deviation.

A multiple waypoints trajectory planning is introduced in order to ensure the planned trajectory is smooth and is able to guide the robot to pass through all the required waypoints at the specified position, orientation, velocity and time.

An actuator is a device that makes a machine or another device work. It is the component of a machine that is responsible for moving and controlling a mechanism or system.

A steering column is a shaft that connects the steering wheel of a vehicle to the rest of the steering mechanism.

In this controller system, the controller computes the vehicle velocity by simulating the vehicle speeds at different vehicle acceleration and deceleration profiles. The maximum velocity/acceleration/jerk of the steering actuator are taken under consideration as part of this mechanism.

A steering actuator is a device that is used to assist with the steering of a vehicle. The most common type of steering actuator is a double-ended, hydraulic ram that is able to push out both ends of the device. When the actuator is mounted to a chassis, the rams on either end of the actuator push against the steering linkage, effectively aiding in the steering of the vehicle. Sensors located on the steering linkage use computer assistance to activate the actuator and apply the correct amount of steering assistance or hydraulic pressure.

The controller selectively searches the velocity profile space by simulating faster trajectories first. The simulator also takes under consideration the load of the vehicle, the slip of the road, and/or flipping conditions.

In this system, the controller uses only trajectories/speed profiles that either minimize or threshold accelerations within the cab or compartments of the vehicle. The controller commands the vehicle to follow one of the trajectories that satisfy the maximum allowed deviation constraints. The control mechanism is also simulated for pure pursuit/vector pursuit/spline or different speed profiles.

The search mechanism for finding the speed profiles that meet the maximum allowed constraints are genetic algorithms/a*/Dyjkstra/Dynamic programming/Simplex or another optimization algorithm.

Genetic algorithms are search heuristics that are inspired by Charles Darwin's theory of natural evolution. This algorithm reflects the process of natural selection where the fittest individuals are selected for reproduction in order to produce offspring of the next generation.

A* algorithms are computer algorithms that are widely used in pathfinding and graph traversal, which is the process of finding a path between multiple points, called “nodes”. It enjoys widespread use due to its performance and accuracy.

Dijkstra's algorithm is an algorithm for finding the shortest paths between nodes in a graph, which may represent, for example, road networks. It was conceived by computer scientist Edgar W. Dijkstra in 1956 and published three years later. The algorithm exists in many variants.

Dynamic programming is a technique for solving problems with overlapping sub problems. A dynamic programming algorithm solves every sub problem just once and then saves its answer in a table (array). It avoids the work of re-computing the answer every time the sub problem is encountered.

The Simplex method is a search procedure that sifts through the set of basic feasible solutions, one at a time, until the optimal basic feasible solution (whenever it exists) is identified.

In this system, a variety of control mechanisms such as pure pursuit and vector pursuit are simulated in combination with different speed profiles to find a solution that meets the maximum allowed deviation constraints.

PurePursuit is a path tracking algorithm. It computes the angular velocity command that moves the robot from its current position to reach some look-ahead point in front of the robot. The linear velocity is assumed constant; hence you can change the linear velocity of the robot at any point. The algorithm then moves the look-ahead point on the path based on the current position of the robot until the last point of the path. You can think of this as the robot constantly chasing a point in front of it. The property LookAheadDistance decides how far the look-ahead point is placed.

The concept of vector pursuit tracking algorithm is to calculate an instantaneous screw that describes the motion of the vehicle from its current position and orientation to a position and orientation on the planned path. Once the desired motion is determined, a controller is required to track this desired motion.

In this system, the controller has a table that specifies the maximum speed that a trajectory can be driven which is based on the angle defined by subsequent points (two or more) in that trajectory.

In this system, the controller only uses the points of the trajectory that are close to the vehicle, ignoring or de-weighting points of the trajectory that are further away from the vehicle.

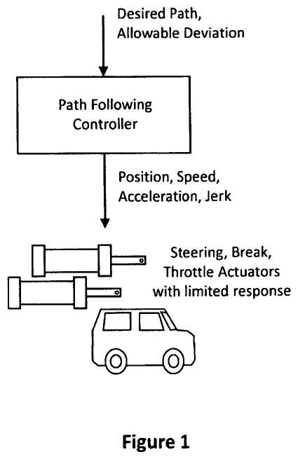

FIG. 1 shows the desired path and allowable deviation for the path following controller and monitors the position, speed, acceleration, and jerk. The simulators control the steering, brake, and throttle actuators with limited response.

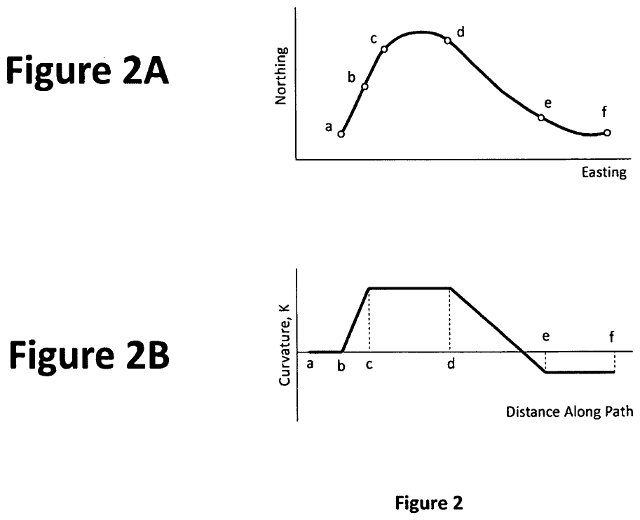

FIG. 2A shows a path with multiple segments which consists of a straight segment (a-b), a clothoid segment turning to the right (b-c), a constant curvature segment (c-d), a second clothoid segment turning to the left (d-e), and a second constant curvature segment (e-f). FIG. 2B shows the Curvature, K, which is the change in the heading per change in distance along the path. The curvature of a vehicle's path is often proportional to the steering wheel position. A clothoid segment has a constant curvature rate. A vehicle following a clothoid would turn the steering wheel at a constant rate.

When generating continuous curvature paths, clothoid segments are needed to connect straight segments to perfect arc segments.

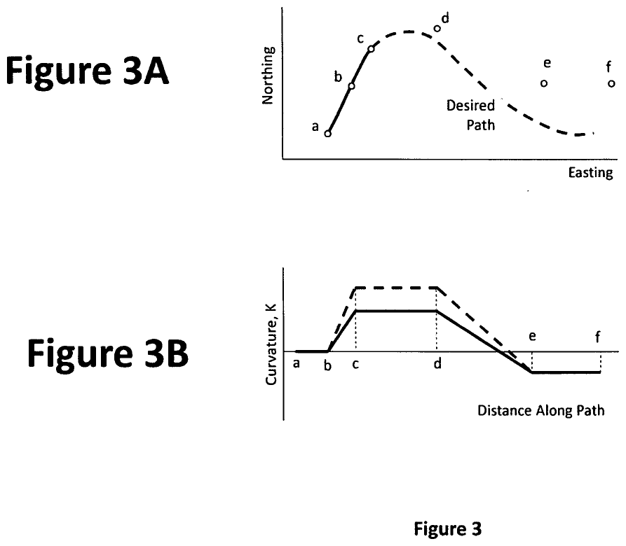

FIG. 3A shows that in the case of a vehicle following the dashed path, if the steering actuator is not fast enough, the vehicle cannot follow the clothoid (b-c) and the resulting path deviates from the desired path. The vehicle could have followed the desired path better if it continued the clothoid past ©, i.e. kept turning longer. It could have also started turning earlier, before (b). It could also drive slower. As can be seen in FIG. 3B, The Distance Along Path is equal t time multiplied by speed. If the vehicle drives slower, then it has more time to make the turn. It would be able to follow exactly or at least, not do as poorly.

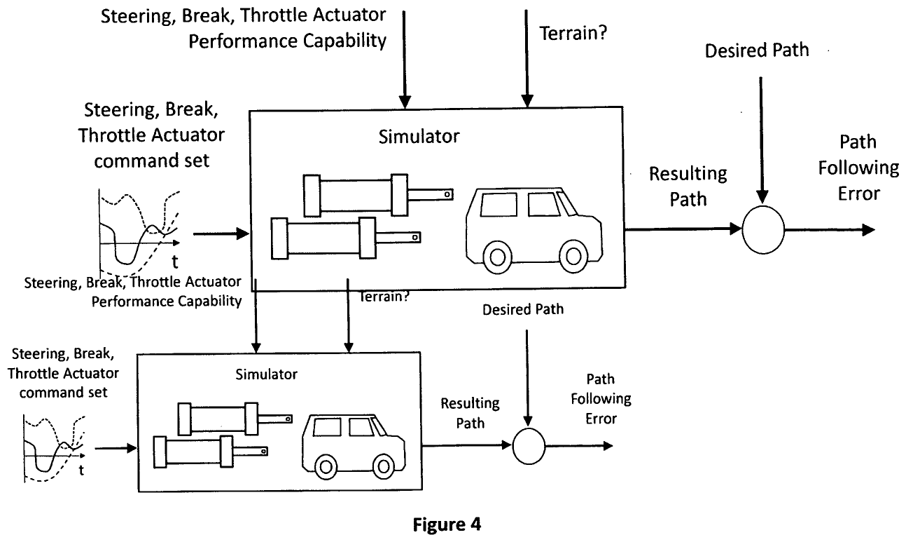

FIG. 4 shows a simulator computing the vehicle response to actuator commands for a given actuator performance capability and possibly terrain. Comparing resulting path to the desired path provides the path following error, for the given actuator command set. The simulator could use raw actuator position commands as a function of time or higher-level commands that use a control servo.

1. A control system that controls to follow an arbitrary trajectory comprising:
a vehicle with an actuated steering column, where the actuator has a maximum steering rate and/or maximum steering acceleration and/or a maximum steering jerk;
a system for controlling the vehicle speed (actuated accelerator and/or brake);
a trajectory (possibly composed of waypoints) that dictates the path to be followed by the vehicle;
a maximum allowed deviation from that trajectory; and
a controller that modifies the velocity of the autonomous vehicle to allow the vehicle to follow the trajectory within the maximum allowed deviation.

2. The system of claim 1 wherein the controller computes the vehicle velocity by simulating the vehicle speeds at different vehicle acceleration and deceleration profiles.

3. The system of claim 1 wherein the maximum velocity/acceleration/jerk of the steering actuator are taken under consideration as part of this mechanism.

4. The system of claim 1 wherein the controller selectively searches the velocity profile space by simulating faster trajectories first.

5. The system of claim 1 wherein the simulator takes under consideration the load of the vehicle, slip of the road, and/or flipping conditions

6. The system of claim 1 wherein the controller uses only trajectories/speed profiles that either minimize or threshold accelerations within the cab or compartments of the vehicle.

7. The system of claim 1 wherein the controller commands the vehicle to follow one of the trajectories that satisfy the maximum allowed deviation constraint.

8. The system of claim 1 wherein the control mechanism being simulated is pure pursuit/vector pursuit/spline at different speed profiles.

9. The system of claim 1 wherein the search mechanism for finding the speed profiles that meet the maximum allowed constraints are genetic algorithms/A*/Dyjkstra/Dynamic programing/Simplex or another optimization algorithm.

10. The system of claim 1 wherein a variety of control mechanism (pure pursuit/vector pursuit/ . . . ) are simulated in combination with different speed profiles to find a solution that meets the maximum allowed deviation constraints.

11. The system of claim 1 wherein the controller has a table that specifies the maximum speed that a trajectory can be driven is based on the angle defined by subsequent points (2 or more) in that trajectory.

12. The system of claim 1 wherein the controller only uses the points of the trajectory that are close to the vehicle, ignoring or de-weighting points of the trajectory that are further away from the vehicle.
